(19) United States
(12) Patent Application Publication
(10) Pub. No.: US 2026/0287167 A1
(43) Pub. Date: Sep. 24, 2026

(54) LIGHTING ELEMENT FOR SLIDING DOORS

(71) Applicant: Southern Engineering s.r.o., Písek (CZ)

(72) Inventors: Karel FRÝD, Týn nad Vltavou (CZ); Jan MAŠEK, Písek (CZ)

(73) Assignee: Southern Engineering s.r.o., Písek (CZ)

(21) Appl. No.: 19/473,225

(22) PCT Filed: Apr. 12, 2024
(86) PCT No.: PCT/CZ2024/050027

§ 371 Date: Oct. 7, 2025

(30) Foreign Application Priority Data
Apr. 13, 2023 (CZ) PV 2023-143

(51) Int. Cl. F21V 33/00; E05D 15/06; E05F 15/632

(52) U.S. Cl. CPC F21V 33/006; E05D 15/0652; E05F 15/632; E05Y 2400/814; E05Y 2400/822; E05Y 2900/132

(57) ABSTRACT

Sliding door devices can be designed with a lighting element of the sliding doors integrated into the door track rail (housing). The light source for the lighting element can be one or more LED diodes, an LED strip, a laser, a bulb or a projection source. The lighting element for sliding doors can be installed especially in motor-driven doors, but alternatively, it can also be used for non-motorized doors.

### FIELD OF THE INVENTION

The invention generally relates to sliding door devices. Specifically, it concerns the lighting of sliding doors integrated into the door track rail (housing).

### PRIOR ART

In modern architecture, sliding doors are increasingly used, both as main entrance doors to buildings and as interior doors within buildings. Sliding doors with automatic opening/closing are particularly used in buildings with high traffic, where touchless door movement is advantageous, such as in stores, banks, or administrative buildings. Sliding door systems are known, for example, from documents DE 102004031531 A1 , DE 10260109 A1 , DE 102005034224 A1 , WO 2004/092521 A1 , or US 2015/0285489 A1. As interior doors, automatic sliding doors functioning without human touch are practically a necessity in hospitals today. For practical reasons, it is necessary to illuminate door passages, not only at night but also during the day, especially in poor natural light conditions or indoors. Lighting of the door passage and/or its surroundings is usually achieved with one or more lighting bodies, which are placed on the ceiling near the doors and/or on the walls beside the doors, or possibly above the doors. Although such installed lighting illuminates well the doors and their surroundings, the actual door passage itself is usually not well lit or may even be in the shadow of various objects around the doors.

### SUMMARY OF THE INVENTION

The present invention addresses the problem of insufficient lighting of the door passage, especially in automatic sliding doors, by providing a lighting element integrated into the door track rail (housing).

The term “integrated”in this context means that the lighting element is placed inside the door track rail (housing), or directly on/to this rail (housing).

Lighting by means of the lighting element according to the invention improves the illumination of the door passage space, leads to better orientation of people, allows for signalling door status changes, signalling for people with impaired hearing, security signalling (fire alarm, security system alarm, etc.), and can also be a source of aesthetic effects. Using the lighting element according to the invention eliminates the need to install an additional light source next to or above the door, making the installation of the lighting element according to the invention simpler and saving financial resources.

Automatic sliding doors come in many variants, most commonly single-leaf or double-leaf, or telescopic. The door leaves are hung (typically by means of a carriage) in the door track rail (housing) or on the sliding door rail (housing), which is installed above the door opening/passage and firmly attached to the door frame, the wall above the door opening or to the ceiling, or may be inserted directly into the wall for built-in doors whose leaves also slide into cavities in the wall. Doors usually have an electric or magnetic drive, but the sliding doors may be operated also with manual motion. The door drive is usually a linear motor or a rotary motor with a belt drive. The term “door track rail (or housing)” in this text does not refer to a construction housing for embedding doors into the wall. The door track rail (housing) typically contains mainly the mechanism for hanging the door leaves, power supply/lines, door drive, the door drive main control PCB assembly (i.e., a printed circuit board containing control electronics, especially a microcontroller or other integrated circuits programmed for door drive control and possibly other components, e.g., power elements), and sensors. The door track rail (housing), hereinafter also referred to as “rail” or “housing”, comprises a rail or is directly formed by it. The rail may have a closed “U” shape profile or an open profile. In the rail (or housing), a carriage moves, and the door leaf is hung on the carriage. The door leaf movement is advantageously solved, for example, with a PMSM (Permanent Magnet Synchronous Motor) motor, or another type of motor such as a BLDC (“Brushless DC” motor with electronic commutation), SynRM (Synchronous Reluctance Motor), or Asynchronous brushless motor. The main parts of the motor are the stator containing electromagnets and the sliding part of the motor placed on the carriage, which contains permanent magnets, as is the case with the PMSM motor, or is without magnets, as is the case with the SynRM motor. Appropriate switching of the stator's electromagnets causes the carriage to move.

The position feedback of the sliding part of the motor (carriage) is read from suitable position sensors (e.g., Hall sensors, magneto-resistive sensors, other magnetic, optical, or mechanical sensors), which are suitably placed, typically form part of the stator. The interconnection of the stator and the main control PCB assembly is made by a cable in the basic embodiment. Interconnection or connection means a connection that allows the transfer of electrical energy (e.g., for powering a device) and/or data transfer, i.e., a connection by an electrical installation cable and/or a data cable, advantageously a hybrid cable combining both functions. The stator may optionally be integrated with the main control PCB assembly. The power cable is connected via terminals secured with screws or other fixing means. The movement of the doors in another embodiment may be solved by a motor with a belt drive or may be purely manual (hand-operated). The interconnecting cable and the power cable can be replaced by any combination of cables, connectors, soldered, unsoldered joints (pressfit, terminals, screw connections, etc.), so the term “able” thus includes multiple cables and all mentioned alternatives and combinations. In the alternative case of manually operated doors, the door track rail (housing) itself does not contain any electrical components, and to install the lighting element according to the invention, the housing must be modified by adding a power cable for the lighting element.

The main feature of the lighting element according to the present invention is that it is integrated into the door track rail (housing), meaning it is entirely installed into the door track rail (housing), or directly on this rail (housing). The lighting element comprises a light source and a lighting element assembly, which contains electrical and electronic components for powering and controlling the light source, especially a microcontroller or another integrated circuit for controlling the light source, and possibly power elements. The term “assembly” in this description means a printed circuit board or another equivalent connection of electronic components. In one advantageous embodiment, the lighting element assembly may be a PCB assembly, possibly fully integrated into the door drive main control PCB assembly, meaning all components necessary for connecting and controlling the light source are part of the main control PCB assembly. In another embodiment, the lighting element assembly is a separate board (assembly) electrically connected to the main control PCB assembly. The term “lighting element assembly” includes multiple assemblies, whose connection may be serial, parallel, or a combination thereof. The light source is understood to include not only standard sources such as a bulb or LED but also a projection source or UV light source.

The target of the lighting or light projection is primarily the door passage itself and its surroundings, where the surroundings may include both near and far surroundings, in the case of, for example, light projection, even several meters. The lighting element with a projection source can also function to display information or as a security element for the hearing impaired, etc. When the doors are permanently open, the lighting element can also be used for permanent illumination of the door area. The lighting element according to the invention can not only illuminate the ground in the door passage but also the wall (e.g., in the direction of the door frame) or the top edge of the door or the ceiling.

The light source can specifically be, for example, LED diodes, LED arrays, LED diodes with integrated power elements or control circuits, LED strips, bulbs, fluorescent lights, lasers, projection sources (projectors), ultraviolet (UV) sources, or other light sources. In advantageous embodiments, the light source can be supplemented with one or more light guides, reflective surfaces or mirrors, or other optical elements, which allow for improved light distribution or changing the angle of illumination, thereby, for example, enlarging the illuminated space. In case of using a light source mounted outside on the door track rail/housing (exposed on the housing), it is possible to illuminate a wider space around the doors and/or specific spots (spot light). The term “light source” in this description includes multiple light sources; the use of the term in the singular includes the meaning of the plural. The term “light source” thus includes one or more identical or different light sources.

In an advantageous embodiment, the light source is LEDs, which create a cone of light illuminating the place of passage from above. In another advantageous embodiment, the light source is a series of LED lights, which are distributed in the direction of door movement. The feature “light source” in this embodiment is realized by a series of LED diodes.

The lighting element can be mounted directly into the door track rail (housing), or externally (from above, from the side) on this housing, and possibly connected to the control electronics of the sliding doors in the following basic ways:
1. The lighting element is essentially formed by one or more light sources (e.g., LEDs) directly mounted on the door drive system's main control PCB assembly (direct soldering to the PCB or placement in sockets, connectors). An alternative to this solution is connecting the light source (e.g., LED) to the printed circuit board of the main control PCB assembly using a cable.

Another alternative is placing the lighting element directly on the PCB of the main control PCB assembly, which is, however, located outside the housing. In this case, the main control PCB assembly of the door drive system contains all components for connecting and controlling the light source, thus also serving the function of the lighting element PCB assembly, in other words, the lighting element PCB assembly is fully integrated into the main control PCB assembly. The microcontroller or another integrated circuit for controlling the door drive is programmed not only for controlling the movement of the door but also for controlling the light source, i.e., the timing and intensity of lighting depending on the position of the door leaf or the intensity of ambient lighting or time dependency, or a combination of these approaches.
2. The lighting element comprises a light source and a lighting element (PCB) assembly, which is connected to the main control PCB assembly. In this case, the lighting element PCB assembly comprises a microcontroller or another integrated circuit and possibly may contain power elements (transistors, thyristors, LED drivers). The microcontroller or another integrated circuit of the lighting element is programmed to control the light source, i.e., the timing and intensity of lighting depending on the position of the door leaf, possibly on time dependency from the moment of activation and the intensity of ambient lighting, or a combination of these approaches.

An alternative is to include a power electronics PCB assembly as a separate assembly (board) between the main control PCB assembly and the lighting element (PCB) assembly.

The light source can be controlled:
directly from the main control PCB assembly (switching one source, sequential switching of multiple sources, PWM (Pulse Width Modulation) regulation or similar, setting colour/temperature of light), especially in the case where the light source is directly on the main control PCB assembly (e.g., individual LEDs powered on the main board PCB assembly, LED strip soldered to the main board PCB assembly). To control the light source, a microcontroller or another integrated circuit, the main control PCB assembly of the door drive, and possibly power elements of the main control PCB assembly of the door drive are used. The light source can also be controlled, for example, by serial communication of LED diodes, LED modules with integrated control circuits.
from one or more lighting element PCB assemblies by a microcontroller or another integrated circuit of the lighting element (switching one source, sequential switching of multiple sources, setting colour/temperature of light), advantageously using PWM regulation, which applies in the case where part of the control/power electronics is mounted outside the main control PCB assembly, i.e., on the lighting element PCB assembly and possibly on the power electronics PCB assembly, and is connected to it (cable/connector board-to-board, etc.).

There are thus 2 main implementation options:
1) The lighting element is fully installed on one PCB, i.e., on the main control PCB assembly of the door drive, specifically, the light source is connected directly to the main control PCB assembly and is controlled by its microcontroller or another integrated circuit.
2) A lighting element, which comprises a light source and a lighting element (PCB) assembly with at least part of the control/power electronics (microcontroller or another integrated circuit, possibly power elements) for controlling the light source, is installed into the door track housing, possibly with a power electronics PCB assembly.

The main control PCB assembly, the lighting element PCB assembly, and the power electronics PCB assembly can be realized in the form of several PCB's.

Lighting can be controlled depending on the movement/position/operational state of the door drive. The brightness of the light can be adjusted in increments or continuously, or the brightness depends on the position of the door leaf, or on time dependency from the moment of activation.

In an advantageous embodiment, gradual continuous control of LED brightness depending on the position of the door leaf, or gradual continuous control of brightness depending on the time since the last activation of door movement are used.

Lighting can be activated or controlled remotely (a higher-level system such as a security system, or central building control, so-called smart home/smart building).

In one advantageous embodiment, the lighting can be directed so that it illuminates a wider space than just the door passage itself, especially in the case where the lighting is a projector intended for projecting an image, text, or symbol, which is projected, for example, on the floor in front of the doors.

The lighting element can be supplemented with a sound module, which provides audio information about the door status or the position of the leaves. The sound module can also serve to provide a warning or alarm signal (e.g., door status signalling for the blind/visually impaired, signalling forced door opening).

The advantageous embodiments of the invention can be combined with each other.

Typical examples of lighting installations according to the invention into the door track rail (housing) include the following:
1. Doors in offices, office buildings, hospitals—use of projection lighting not only for illumination but also, for example, for projecting time, opening hours, advertising, notifications, etc. Control/supervision/setting possible through a building automation system, wired connection, for example, using the MODBUS protocol and RS485 bus (“MODBUS over RS485”), or any other communication system with similar functionality.
2. Doors in hospitals, nursing homes—LED lighting with light signaling function, for example, flashing, for warning during closing or opening for, for example, the hearing impaired. Control/supervision/setting possible through a building automation system, wired connection, for example, MODBUS over RS485, or any other communication system with similar functionality.
3. In households (especially for technology enthusiasts)—LED lighting with smooth dimming and brightening. Control/supervision/setting possible through a smart home system, for example, via Zigbee. Doors can also be used as part of a security system, where in case of space intrusion, the light starts signalling, for example, by flashing.

Upon activation (e.g., by a button, activating the drive by gently pushing the door leaf (push&go), PIR sensor, radar sensor, remotely, smart home with sensors and actuators), the doors start to open and the light begins to gradually brighten to maximum intensity. The level of maximum intensity can be set or the light deactivated. Closing occurs in the opposite manner. The intensity of lighting can be controlled automatically—externally (wired or by a sensor from the smart home) or internally by a sensor, or software through the smart home (e.g., lighting intensity depending on the intensity of ambient lighting, or time of day).
4. In households (for the average user)—LED lighting with smooth dimming and brightening. Basic settings can be made manually with trimmers/switches.

The subject of the present invention is a lighting element for sliding doors, wherein the door track rail (housing) comprises a movable carriage, on which the door leaf is hung, a motor for moving the carriage comprising a stator and a sliding part of the motor placed on the carriage, and the main control PCB assembly of the door drive comprising a microcontroller or another integrated circuit for controlling the door drive, wherein the lighting element comprises a light source connected to the lighting element assembly, where the assembly comprises a microcontroller or another integrated circuit for controlling the light source, and both the assembly and the light source are integrated into the rail (housing), and the lighting element assembly is an independent assembly electrically connected to the main control PCB assembly of the door drive or the assembly is fully integrated into the main control PCB assembly of the door drive.

In an advantageous embodiment, the lighting element for sliding doors further comprises a power electronics PCB assembly, which is connected between the lighting element (PCB) assembly and the main control PCB assembly of the door drive.

The light source for the lighting element for sliding doors is selected from LED diodes, LED arrays, LED diodes with integrated power elements or control circuits, LED strips, bulbs, fluorescent lights, lasers, projection sources, ultraviolet sources, or their combination.

In another advantageous embodiment, the lighting element for sliding doors further comprises optical elements selected from light guides, mirrors, reflective plates, and lenses.

In another advantageous embodiment of the lighting element for sliding doors, the light source is connected directly to the main control PCB assembly, with the micro-controller or another integrated circuit for controlling the door drive simultaneously programmed to control the light source.

In the embodiment for manually operated (motorless) sliding doors, the lighting element comprises a lighting element assembly and a light source connected to the assembly, wherein the assembly is adapted for connection to a power source and contains a microcontroller or another integrated circuit for controlling the light source, and both the assembly and the light source are integrated into the door track rail (housing). Such a lighting element advantageously comprises a position sensor connected to the lighting element (PCB) assembly. Even in this embodiment, the light source is selected from LED diodes, LED arrays, LED diodes with integrated power elements or control circuits, LED strips, bulbs, fluorescent lights, lasers, projection sources, ultraviolet sources, or their combination. Advantageously, it further comprises optical elements selected from light guides, mirrors, reflective plates, and lenses.

In another advantageous embodiment, the lighting element for sliding doors comprises a sound module.

The advantageous embodiments can be freely combined.

### CLARIFICATION OF DRAWINGS

FIG. 1 is a schematic view of sliding doors with basic components of the door track rail (housing).

FIG. 2 is a schematic view of an advantageous embodiment of the lighting element for sliding doors.

FIG. 3 is a schematic view of another advantageous embodiment of the lighting element for sliding doors.

FIG. 4 is a schematic view of another advantageous embodiment of the lighting element for sliding doors.

FIG. 5 is a schematic view of another advantageous embodiment of the lighting element for sliding doors.

FIG. 6 is a schematic view of another advantageous embodiment of the lighting element for sliding doors.

FIG. 7 is a schematic view of another advantageous embodiment of the lighting element for sliding doors.

FIG. 8 is a schematic view of another advantageous embodiment of the lighting element for sliding doors.

### EXAMPLES OF EMBODIMENTS OF THE INVENTION

It is to be understood that the examples described below are for illustrative purposes only and are not intended to limit the invention to these examples. Certainly, a person skilled in the art will be able to prepare equivalents to the specific embodiments of the invention described herein by means of routine experimentation. These equivalents are also included within the scope of protection defined by the following patent claims.

### Example 1

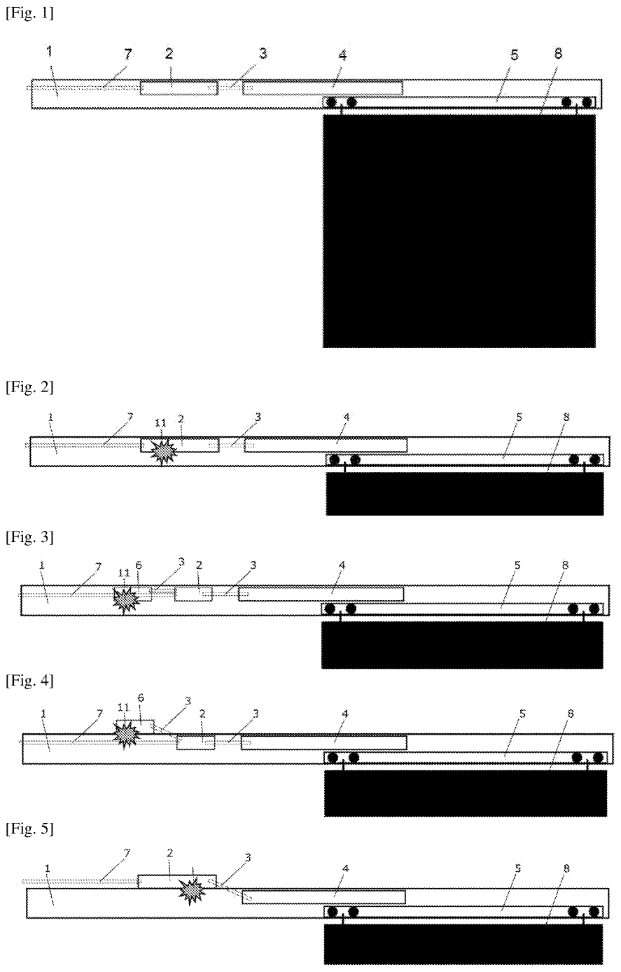

The door track rail 1 is directly formed by an aluminium rail, in which a carriage 5 moves. On the carriage 5, the door leaf & is hung, which is shown in the open position in FIG. 1. The movement of the leaf 8 is solved by a PMSM motor. The main parts of the motor are the stator 4 consisting of electromagnets and the sliding part of the motor placed on the carriage 5 containing permanent magnets. Appropriate switching of the electromagnets of the stator 4 causes the carriage 5 to move. The position feedback of the sliding part of the motor, i.e., the carriage 5, is read from Hall sensors, which are also part of the stator 4. The connection of the stator 4 and the main control PCB assembly 2 is made by a cable 3 with connectors at both ends. The main control PCB assembly 2 contains a microcontroller or another integrated circuit for controlling the door drive and power elements (transistors). The power cable Z is connected via terminals secured with screws.

In the exemplary embodiment shown in FIG. 2 (in the figure, the door leaf 8 is shortened in the vertical direction for greater clarity of components placed in the rail 1), the lighting of the sliding door passage is solved by a lighting element, which comprises a light source 11 directly powered to the main control PCB assembly 2. The light source 11 is one or more LED diodes, which are placed on this main control PCB assembly 2. The main control PCB assembly 2, through a microcontroller or another integrated circuit, and possibly power elements, controls the light source 11, thus also serving the function of the lighting element PCB assembly 6. The lighting element in this embodiment comprises the light source 11 and the PCB assembly 6 of the lighting element, which is fully (physically and functionally) integrated into the main control PCB assembly 2.

Switching, or dimming, is performed using programmatically controlled pulse-width (PWM) modulation in relation to the position and status of the door leaf 8. The basic light function-the light gradually brightens during the opening of the door leaf 8 to a defined maximum brightness, remains at this brightness for the duration of the door leaf 8 being open, and then follows a gradual dimming during the closing of the door leaf 8.

In alternative variants of this embodiment, the light source 11, in addition to LED diodes, can also use LED strips, bulbs, fluorescent lights, projection sources, laser or other light sources. The possibility of mounting these light sources 11 is not only soldering but, for example, unsoldered joints like pressfit, terminals, screw connections, etc., can also be used. A cable or another type of conductive connection can also be used; LED diodes or LED strip can be connected by an extension cable plugged into the main control PCB assembly 2 using a connector. In another variant of the door track housing, the main control PCB assembly 2 can be merged with the stator 4 PCB assembly, thus eliminating the need for cable 3. In another variant of the door track rail (housing), the main control PCB assembly 2 can be carried out in the form of several interconnected PCB's.

### Example 2

In this embodiment shown in FIG. 3, the basic components of the door track rail (housing) 1 are the same as in Example 1.

The lighting of the sliding door passage in this embodiment is solved by a lighting element, which contains LED diodes as the light source 11 and the lighting element PCB assembly 6. The lighting element PCB assembly 6 comprises a microcontroller or another integrated circuit programmed to control the light source 11. The LED diodes are directly powered to the lighting element PCB assembly 6 placed in the rail 1. The connection of the main control PCB assembly 2 of the system with the lighting element PCB assembly 6 is made by a cable 3 with connectors at both ends.

Switching, or dimming, is performed using programmatically controlled pulse-width modulation (PWM) in relation to the position and status of the door leaf 8, possibly on time dependency from activation. The basic light function-the light gradually brightens during opening to a defined maximum brightness, remains at this brightness for the duration of being open, and then follows a gradual dimming during closing.

In this embodiment, further variants are possible analogous to the variants mentioned in Example 1.

### Example 3

In this embodiment shown in FIG. 4, the basic components of the door track rail (housing) 1 are the same as in Example 1.

The lighting of the sliding door passage in this embodiment is solved by a lighting element, which is placed outside the rail 1. Placing the lighting element outside the rail 1 means that it is placed on the outer side (e.g., from the side or from above) directly on the rail 1. The lighting element comprises a light source 11, in this case, at least one LED diode directly powered to the lighting element PCB assembly 6 placed on the rail 1 from the outside. The lighting element PCB assembly 6 comprises a microcontroller or another integrated circuit programmed to control the light source 11. The connection of the main control PCB assembly 2 of the system with the lighting element PCB assembly 6 is made by a cable 3 with connectors at both ends.

The lighting mode is identical to the mode described in Example 1.

In this embodiment, further variants are possible analogous to the variants mentioned in Example 1.

### Example 4

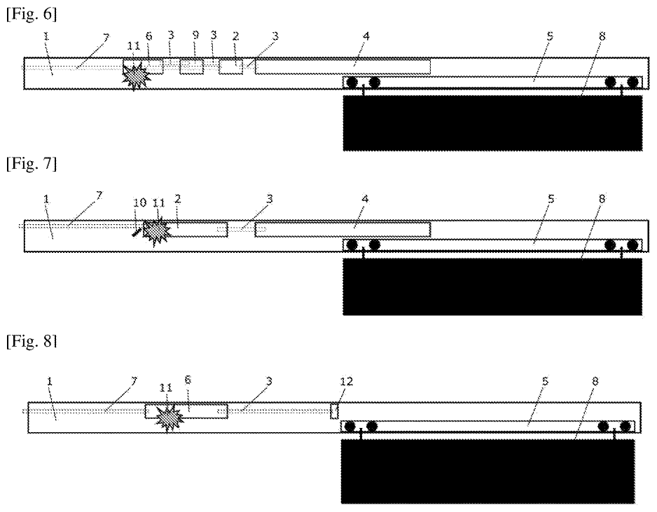

In this embodiment shown in FIG. 5, the basic components of the door track rail (housing) 1 are the same as in Example 1.

The embodiment demonstrates the case where the main control PCB assembly 2 is placed on the rail 1. The lighting of the door passage is solved by a lighting element, which comprises a light source 11, which is at least one LED diode directly powered to the main control PCB assembly 2 of the door drive, thus also serving the function of the lighting element PCB assembly 6 (the PCB assembly 6 of the lighting element is fully integrated into the main control PCB assembly 2).

The lighting mode is identical to the mode described in Example 1.

In this embodiment, further variants are also possible analogous to the variants mentioned in Example 1.

### Example 5

In this embodiment shown in FIG. 6, the basic components of the door track rail (housing) 1 are the same as in Example 1.

The lighting of the sliding door passage in this embodiment is solved by a lighting element, which comprises a light source 11 (LED diodes) directly powered to the lighting element PCB assembly 6 placed in the rail 1. The lighting element PCB assembly 6 comprises a microcontroller or another integrated circuit programmed to control the light source 11. The lighting element additionally comprises a power electronics PCB assembly 9. The connection of the main control PCB assembly 2 of the system with the lighting element PCB assembly 6 is made through the power electronics PCB assembly 2 using cables 3 with connectors at both ends. There may be multiple lighting element PCB assemblies 6; the connection can be serial, parallel, or a combination thereof.

The lighting mode is identical to the mode described in Example 1.

In this embodiment, further variants are also possible analogous to the variants mentioned in Example 1.

### Example 6

In this embodiment shown in FIG. 7, the basic components of the door track rail (housing) 1 are the same as in Example 1.

The lighting/displaying in this embodiment is solved by a light source 11, which is a projector directly powered to the main control PCB assembly 2 of the door drive system, with the lighting element further comprising a mirror 10. The light cone of the projection is directed by the reflective mirror 10 to a selected target surface. The function of the lighting element PCB assembly 6 here is served by the main control PCB assembly 2 (the PCB assembly 6 of the lighting element is fully integrated into the main control PCB assembly 2). The light source 11 implemented by the projector advantageously displays the current time information. In alternative embodiments, it can display text or an image, for example, a company logo.

Switching, or dimming, or displaying information is performed programmatically via a data bus, for example, SPI (Serial Peripheral Interface) in relation to the position and status of the door leaf 8, possibly on time dependency from activation. The basic light function-the light gradually brightens during opening to a defined maximum brightness, remains at this brightness for the duration of being open, and then follows a gradual dimming during closing.

### Example 7

This example is an alternative embodiment of the lighting element for lighting motorless sliding doors. Inside the rail 1, a carriage 5 moves, on the carriage 5, the door leaf 8 is hung, which is shown in the open position in FIG. 8. The movement of the leaf 8 is solved manually. The position feedback of the carriage 5 is read from the position sensor 12, which is a Hall sensor. On the carriage 5, there is an activation magnet for the Hall sensor. The magnet passes under the sensor 12 during the movement of the leaf 8, and the light source 11 lights up. The connection is made by a cable 3 with connectors at both ends. The power cable Z is connected via terminals secured with screws.

The lighting is solved by a light source 11, which are LED diodes directly powered to the lighting element PCB assembly 6. Switching, or dimming, is performed using programmatically controlled pulse-width modulation (PWM) in relation to the position and status of the door leaf 8, possibly on time dependency from activation. The basic light function-the light gradually brightens during opening to a defined maximum brightness, remains at this brightness for the duration of being open, and then follows a gradual dimming during closing.

The lighting element in this case comprises the light source 11, the lighting element PCB assembly 6, and the position sensor 12 of the door leaf 8, which is connected to the lighting element PCB assembly 6. The lighting element PCB assembly 6 comprises a microcontroller or another integrated circuit programmed to control the light source 11.

### LIST OF REFERENCE NUMERALS

1 . . . door track rail (housing)
2 . . . door drive main control PCB assembly
3 . . . connecting cable (with connectors)
4 . . . motor stator (electromagnets)
5 . . . carriage with sliding part of the motor
6 . . . lighting element assembly
7 . . . power cable
8 . . . door leaf
9 . . . power electronics PCB assembly
10 . . . mirror
11 . . . light source
12 . . . position sensor

1. A lighting element for sliding doors, having a door track rail (1) that comprises a movable carriage (5), on which a door leaf (8) is hung, a motor for moving the carriage (5) comprising a stator (4) and a sliding part of the motor placed on the carriage (5) and the a main control PCB assembly (2) of the door drive containing a microcontroller or another integrated circuit for controlling the door drive, wherein the lighting element comprises a light source (11) connected to an assembly (6) of the lighting element, wherein the assembly (6) comprises a microcontroller or another integrated circuit configured for controlling the light source (11), and both the assembly (6) and the light source (11) are integrated into the rail (1), and the assembly (6) of the lighting element is an independent assembly (6) electrically connected to the main control PCB assembly (2) of the door drive, or the assembly (6) is fully integrated into the main control PCB assembly (2) of the door drive.

2. The lighting element for sliding doors according to claim 1, further comprising a power electronics PCB assembly (9), which is connected between the assembly (6) of the lighting element and the main control PCB assembly (2) of the door drive.

3. The lighting element for sliding doors according to claim 1, wherein the light source (11) is selected from LED diodes, LED arrays, LED diodes with integrated power elements or control circuits, LED strips, bulbs, fluorescent lights, lasers, projection sources, ultraviolet sources, or combinations thereof.

4. The lighting element for sliding doors according to claim 1, further comprising optical elements selected from light guides, mirrors (10), reflective plates, and lenses.

5. The lighting element for sliding doors according to claim 1, wherein the light source (11) is connected directly to the main control PCB assembly (2), with the microcontroller or another integrated circuit configured for controlling the door drive simultaneously programmed for controlling the light source (11).

6. A lighting element for sliding doors, having a door track rail (1) that comprises a movable carriage (5), on which a door leaf (8) is hung, wherein the lighting element comprises an assembly (6) of the lighting element and a light source (11) connected to the assembly (6), wherein the assembly (6) is adapted for connection to a power source and comprises a microcontroller or another integrated circuit configured for controlling the light source (11), and both the assembly (6) and the light source (11) are integrated into the door track rail (1).

7. The lighting element for sliding doors according to any claim 1, further comprising a position sensor connected to the assembly (6) of the lighting element.

8. The lighting element for sliding doors according to claim 6 , wherein the light source (11) is selected from LED diodes, LED arrays, LED diodes with integrated power elements or control circuits, LED strips, bulbs, fluorescent lights, lasers, projection sources, ultraviolet sources, or their combination.

9. The lighting element for sliding doors according to claim 1, further comprising optical elements selected from light guides, mirrors (10), reflective plates, and lenses.

10. The lighting element for sliding doors according to claim 1, further comprising a sound module.
